(19) United States
(12) Patent Application Publication
(10) Pub. No.: US 2002/0099830 A1
(43) Pub. Date: Jul. 25, 2002

(54) Communication unit

(75) Inventor: Erich Viechter, Neusaess (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Fujitsu Siemens Computers GmbH, Munich (DE)

(21) Appl. No.: 09/989,034

(22) Filed: Nov. 21, 2001

(30) Foreign Application Priority Data
Nov. 22, 2000 (DE) 100 57 847.0

(51) Int. Cl. G06F 15/16

(52) U.S. Cl. 709/227

(57) ABSTRACT

The invention relates to a communication unit (3) with a memory (10) for storing data relating to possible communication partners [(2)], a connecting device (11) for establishing communication connections with a communication partner (2) by way of different means of communication and a control unit (9) for triggering the connecting device (11) in order to establish a communication connection utilizing the data that is stored in the memory (10) and/or that can be entered manually. A communication unit according to the invention is characterized by the fact if establishing a connection fails, the control unit (9) triggers the connecting device (11) in such a way that a communication connection is established with another means of communication,

The invention relates to a communication unit with

a memory for storing data of possible communication partners,

a connecting device for establishing communication connections with a communication partner using different means of communication,

a control unit for triggering the connecting device in order to establish a communication connection by using data that is stored in the memory and/or that can be entered manually.

Modern communication systems, such as corporate telephone systems, already have numerous interfaces with computer systems. On one hand, a computer can record calls that were made, allowing for detailed recording of time and cost. On the other hand, using special software, it is also possible to control the telephone system with a computer, thereby allowing the upkeep of, for example, an electronic telephone book based upon which it is possible to establish direct telephone connections to a communication partner. This simplifies the setup of a communication connection considerably and reduces the error frequency due to incorrect input. Missing or incomplete data in the memory can be supplemented manually.

If the desired communication partner cannot be reached, often it is possible to reach him/her with a different means if communication. For example, if the fixed line telephone is not answered, a mobile phone number can be dialed to circumvent the problem. If the mobile telephone is not turned on or not answered, there is still the possibility to send an SMS message or an e-mail. Furthermore, it would be possible to send a fax accompanied by the request for a call back. Even if all data that is necessary for establishing communication connections is stored in the computer, it takes a considerable effort to select each means of communication individually in order to get in touch with the desired communication partner.

It is therefore the subject-matter of the present invention to provide a communication unit that simplifies, employing various means of communication, establishing a communication connection with a communication partner.

According to the invention, this objective is achieved with a communication unit of the above-described kind, which is characterized by the fact that, if establishing a connection fails, the control unit triggers the connecting device in such a way that a communication connection is established utilizing another means of communication.

One means of communication is initially given priority. If it is not possible to establish a connection with this means of communication, for example because the desired communication partner does not accept the connection or is already communicating otherwise via this means of communication, the communication unit according to the invention automatically attempts to establish a connection by way of another means of communication. According to the invention, the above-described possibilities, used to get in touch with a desired communication partner, are performed automatically. Advantageously, in addition to data of the communication partners, the memory also stores text messages that can be forwarded automatically because their content is often identical. Therefore, messages that are sent via SMS or e-mail do not have to be re-entered each time.

Moreover, it is advantageous if priority levels can be assigned to the various means of communication. This allows to determine as to whether one or another means of communication should be applied first, i.e. if an SMS message or an e-mail should be sent first.

Furthermore, it is advantageous if the selection of the means of communication can be influenced by user specifications For cases ruled by a lesser degree of urgency, fewer means of communication are used by the automatic control than for cases of greater urgency Therefore, only in situations of the greatest urgency will it be necessary to dial up the private number of the desired communication partner or to even try reaching her at his vacation phone number. In contrast, dialing a mobile phone number or sending an e-mail are suitable means even in cases that have a lesser degree of urgency.

Using an embodiment, the invention will subsequently be explained in more detail. Shown are in:

a communication unit according to the invention and in
an example for a priority list with stages of urgency.

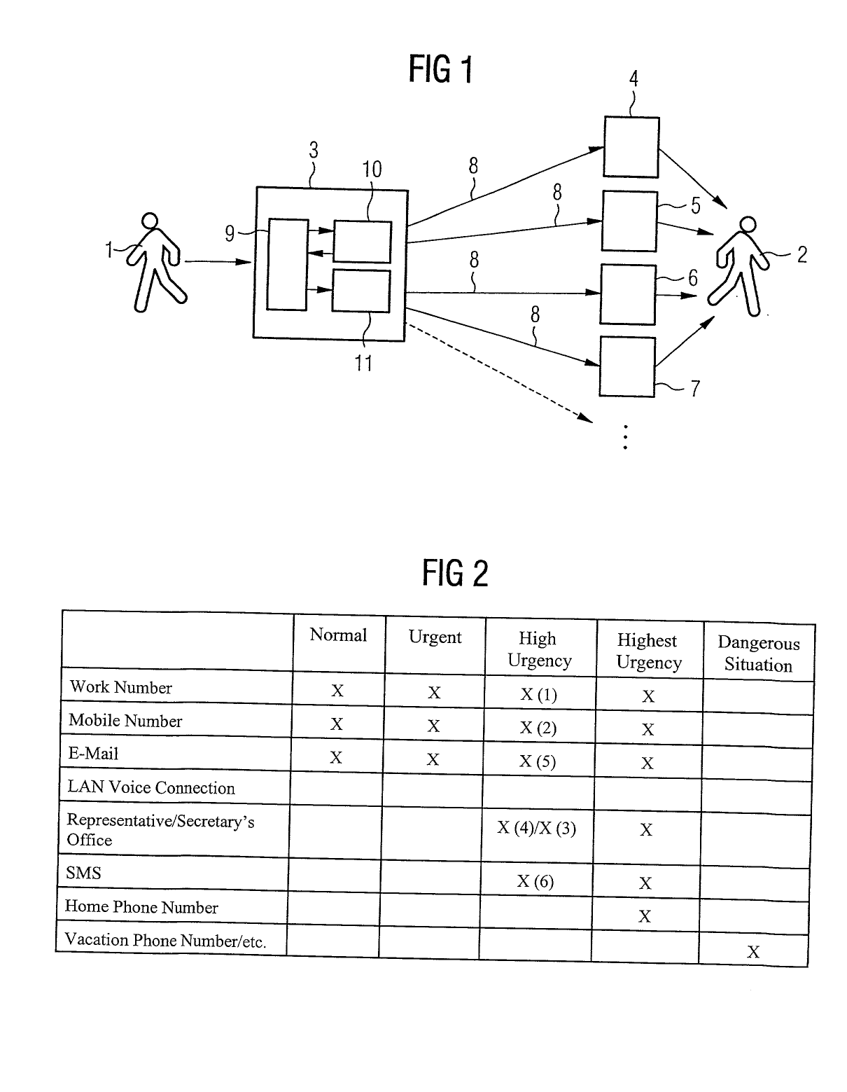

In the representation in FIG. 1, a first person 1 is trying to reach a second person 2. The person 1 has the communication unit 3 according to the invention at his/her disposal. The person 2 can be reached by way of a multitude of means of communication. The available means are a fixed line telephone 4, a mobile telephone 5, an e-mail connection 6 and a LAN voice connection 7. Also available but not shown in the figure are a representative, a secretary's office, an SMS system, a home phone number as well as a vacation phone number. At his point, a variety of additional means of communication are possible which be may integrated easily into the communication unit according to the invention. The communication unit 3 of person 1 is able to use all means of communication in order to establish a connection 8 with person 2.

In a starting situation, person 1 is trying to reach person 2 with a high degree of urgency. Person 1 initially dials the fixed line number of person 2. Person 2, however, does not answer the call. Therefore, person 1 activates the automatic control of the communication unit 3 specifying that the desire to reach the communication partner, i.e. person 2, is extremely urgent. The procedure described in the following is shown in FIG. 2. The X-marks in the columns of the table signify that the corresponding means of communication is available. The numbers, added e.g. in the “high urgency” column, represent the sequence in which the means of communication are to be used. Individual profiles can be stored for each stored communication partner.

A control unit 9 of the communication unit 3 knows now that the person 2 could not be reached via the fixed line telephone 4. Thus, the control unit 9 obtains the number at which person 2 can reached on a cellular phone from the memory 10. A connecting device 11, responsible for establishing the connection, now tries to establish a mobile phone connection with the cellular phone 5 of person 2. If this attempt by the communication unit 3 fails as well, the unit automatically tries to establish a telephone connection to the secretary's office of person 2. The corresponding number is also filed in the memory 10. If neither the secretary's office nor a representative, with whom a connection is attempted, are available to answer the call, a text message is sent to the e-mail connection 6 of person 2. The text message is filed in the memory 10 and applies for various communication partners. Generally, this will be a simple message with a content such as “please call back”. Finally, an SMS message is sent also requesting a call back.

Since the situation is not of the utmost urgency, no attempt will be made to reach person 2 at home

In another starting situation, person 1 also tries to reach person 2 with a high degree of urgency. However, the fixed line connection of person 2 is busy, Person 1 again activates the automatic control of the communication unit 3. In this instance, however, no attempt is made to reach person 2 via a mobile phone 5, because it is known that person 2 is currently on the telephone. But there is the possibility of sending a text message with a request for call back to person 2, either by the e-mail system or as an SMS message.

In the way described above it is possible to store a scenario for any situation in which the attempt is made to get in touch with person 2.

1. Communication unit with,
a memory (10) for storing data of possible communication partners (2),
a connecting device (11) for establishing communication connections with a communication partner (2) using different means of communication,
a control unit (9) for triggering the connecting device (11)
in order to establish a communication connection by using data that is stored in the memory (10) and/or that can be entered manually,
wherein,
if establishing the connection failed, the control unit (9) triggers the connecting device (11) in such a way that a communication connection is established using another means of communication:

2. Communication unit as claimed in claim 1
wherein
text messages can be stored in the memory (10) that can be forwarded with a suitable means of communication,

3. Communication unit as claimed in claim 1
wherein
the means of communication can be assigned priority levels.

4. Communication unit as claimed in claim 1
wherein
the selection of the means of communication can be influenced by way of user specifications.
